(19) United States
(12) Patent Application Publication
(10) Pub. No.: US 2006/0105126 A1
(43) Pub. Date: May 18, 2006

(54) Heat sealable antifog film materials

(76) Inventor: Terrance D. Kendig, Newark, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/274,522

(22) Filed: Nov. 15, 2005

Related U.S. Application Data
(60) Provisional application No. 60/628,454, filed on Nov. 16, 2004.
(60) Provisional application No. 60/664,624, filed on Mar. 23, 2005.

(51) Int. Cl. B32B 27/32

(52) U.S. Cl. 428/35.2; 428/35.7

(57) ABSTRACT

The invention relates to an antifog mono or multilayer film structure comprising at least an external heat sealing layer coated with an antifog agent wherein the external heat sealing layer comprises, or is produced from, an ethylene copolymer or modified ethylene copolymer; the ethylene copolymer is a copolymer or terpolymer or tetrapolymer comprising repeat units derived from ethylene and about 5 to about 50 wt % of one or more polar monomers chosen from the group consisting of vinyl alkanoic acid, acrylic acid, alkyl acrylic acid and alkyl acrylate, the weight percentages being based on the total weight of the ethylene copolymer or modified ethylene copolymer. The mono or multilayer film structure according to the present invention is suitable, inter alia, for packaging fresh refrigerated products and enables clear view of the product inside the package.

This application claims priority to U.S. provisional applications 60/628454, filed Nov. 16, 2004 and 60/664624, filed Mar. 23, 2004, the entire disclosures of which are incorporated herein by reference.

The invention relates to an antifog mono or multilayer film structure, to a process for the manufacture of such structure and to packaging including such structure.

### BACKGROUND OF THE INVENTION

Applications packaging fresh refrigerated products such as meat or poultry require a clear view of the product inside the package. In many cases a packaging film is heat-sealed to the lip or flange of a tray material to protect the product. In such cases there is an area of headspace between the product in the tray and the lidding film. This headspace is generally filled with a modified atmosphere to extend product shelf life. It is essential that the packaged product remain in clear view to the consumer at retail. In order to achieve this aesthetic, an antifog agent is desirable to eliminate the undesirable visual effect caused by wet products that generate high humidity inside the package.

Surfaces of polyethylene (PE) film coated with antifog agents may produce a desired effect, but PE film is not as good packaging material as ethylene copolymers such as ethylene vinyl acetate (EVA) copolymers and ethylene methacrylate (EMA) copolymers. Such ethylene copolymers have very different chemical and physical properties from PE. Inventor's own tests showed that it is difficult to coat an antifog onto films made of ethylene copolymers like EVA and EMA copolymers and that a large amount of antifog agent is required to achieve antifogging effect. One of the problems may be due to the repeat units derived from polar monomers such as acetate or acrylate or to the polarity of sealant employed. Wishing not to be bound by theory, it is believed that the more polar is the film, i.e. the polymer itself and/or the additives included therein like polar sealants (also called tackifiers), the more inefficient is an antifog treatment on such film. It is therefore necessary to apply relatively high concentrations of antifog agents onto the film surface in order to obtain an acceptable antifog effect. This leads to contamination of the ethylene copolymer film thus decreasing its heat-seal functionality and possible loss of peel strength. So far, it is therefore not possible to keep at the same time antifogging, heat-seal functionality and possibly peelability of ethylene copolymer films.

A need therefore exists in the packaging industry for different ethylene copolymer films or laminates with antifogging properties. It is also desirable to develop an antifogging ethylene copolymer film, when exposed and pulled at a given temperature such as 0° C., maintains or increases in heat seal strength and peel strength as well. Such film may facilitate transporting and moving product through distribution. Additionally such antifog film can be used as the lidstock to seal to a tray material and provide the antifog surface interface between the headspace and the product packaged.

### SUMMARY OF THE INVENTION

The invention relates to an antifog mono or multilayer film structure comprising at least an external heat sealing layer coated with an antifog agent wherein the external heat sealing layer comprises, or is produced from, an ethylene copolymer or modified ethylene copolymer; the ethylene copolymer is a copolymer or terpolymer or tetrapolymer comprising repeat units derived from ethylene and about 5 to about 50 wt % of one or more polar monomers chosen from the group consisting of vinyl alkanoic acid, acrylic acid, alkyl acrylic acid and alkyl acrylate, the weight percentages being based on the total weight of the ethylene copolymer or modified ethylene copolymer.

The invention also comprises a process for producing a mono or multilayer antifog film structure as described above, comprising dissolving an antifog agent in a solvent to produce an antifog agent solution; applying the antifog agent solution onto the external heat sealing layer to produce a coating thereon; and optionally curing the coating.

Under “heat sealing layer” it is meant a layer which is typically sealable between 95° C. and 210° C., under pressures ranging between 20 psi and 2000 psi, preferably, between 20 psi and 100 psi, and during periods of time between 0.5 s and 4 s.

### DETAILED DESCRIPTION OF THE INVENTION

The term “film structure” used here may be exchangeable with “laminate” or “sheet”.

The external heat sealing layer may be peelable. Under “peelable heat sealing layer” it is meant a layer which is heat sealed onto a given substrate (for example a tray) and which, when peeled from such substrate under stress and speed, it splits adhesively at the seal interface or cohesively within the sealant layer, but always homogeneously, within the peel layer without substantial delamination of the layer itself and/or the substrate taking place.

The film structure according to the present invention can comprise or be produced from an ethylene copolymer or modified ethylene copolymer or an ionomer thereof. An ethylene copolymer can be a copolymer or terpolymer or tetrapolymer comprising repeat units derived from ethylene and about 5 to about 50%, or about 9 to about 25%, or about 10 to about 19%, or 12 to 15%, by weight (wt %) of a polar monomer, the weight percentages being based on the total weight of the ethylene copolymer, the modified ethylene copolymer or the ionomer thereof. The polar monomer may contain up to about 20 carbon atoms and the alkyl group can be methyl, ethyl, butyl, isobutyl, pentyl, hexyl, or combinations of two or more thereof.

Examples of such polar monomers include vinyl acetic acid, vinyl acetate, vinyl propionate, acrylic acid, methacrylic acid, ethacrylic acid, vinyl acetate, methyl acrylate, ethyl acrylate, methyl methacrylate, ethyl methacrylate, propyl acrylate, propyl methacrylate, isopropyl acrylate, isopropyl methacrylate, butyl acrylate, butyl methacrylate, isobutyl acrylate, isobutyl methacrylate, tert-butyl acrylate, tert-butyl methacrylate, octyl acrylate, octyl methacrylate, undecyl acrylate, undecyl methacrylate, octadecyl acrylate, octadecyl methacrylate, dodecyl acrylate, dodecyl methacrylate, 2-ethylhexyl acrylate, 2-ethylhexyl methacrylate, isobornyl acrylate, isobornyl methacrylate, lauryl acrylate, lauryl methacrylate, 2-hydroxyethyl acrylate, 2-hydroxyethyl methacrylate, glycidyl acrylate, glycidyl methacrylate, poly(ethylene glycol)acrylate, poly(ethylene glycol)methacrylate, poly(ethylene glycol)methyl ether acrylate, poly(ethylene glycol)methyl ether methacrylate, poly(ethylene glycol)behenyl ether acrylate, poly(ethylene glycol)behenyl ether methacrylate, poly(ethylene glycol)4-nonylphenyl ether acrylate, poly(ethylene glycol)4-nonylphenyl ether methacrylate, poly(ethylene glycol)phenyl ether acrylate, poly(ethylene glycol)phenyl ether methacrylate, dimethyl maleate, diethyl maleate, dibutyl maleate, dimethyl fumarate, diethyl fumarate, dibutyl fumarate, dimethyl fumarate, or combinations of two or more thereof and is preferably vinyl acetate, acrylic acid, methacrylic acid, alkyl (meth)acrylate and combinations of two or more thereof.

The acid moiety of an ethylene copolymer may be neutralized with a cation to produce an ionomer. An ethylene copolymer in which the repeat units derived from an acid that is not neutralized is also referred to as ethylene acid copolymer or acid polymer. The neutralization, for example, can range from about 0.1 to about 100, or about 10 to about 90, or about 20 to about 80, or about 20 to about 40 percent, based on the total carboxylic acid content, with a metallic ion. The metallic ions can be monovalent, divalent, trivalent, multivalent, or combinations of two or more thereof. Examples include Li, Na, K, Ag, Hg, Cu, Be, Mg, Ca, Sr, Ba, Cd, Sn, Pb, Fe, Co, Zn, Ni, Al, Sc, Hf, Ti, Zr, Ce, and combinations of two or more thereof. If the metallic ion is multivalent, a complexing agent, such as stearate, oleate, salicylate, and phenolate radicals can be included, as disclosed in U.S. Pat. No. 3,404,134.

The ethylene copolymer can be a blend of one or more ethylene copolymers as described above. For example, an ethylene copolymer can comprise from 1 to 30 wt % of at least one E/X/Y copolymer wherein E comprises ethylene; X is a monomer selected from the group consisting of EVA and EMA; and Y is one or more optional comonomers disclosed above; X is from 0 to 50 wt % of the total weight of the E/X/Y copolymer, Y is from 0 to 35 wt % of the total weight of the E/X/Y copolymer, wherein the weight percentage of X and Y cannot both be 0, and E being the remainder.

Examples of ethylene copolymers include, but are not limited to, ethylene vinyl acetate (EVA), ethylene methyl acrylate (EMA), ethylene ethyl acrylate (EEA), ethyl acrylate (EA), ethylene butyl acrylate (EBA), ethylene isobutyl acrylate/methacrylic acid, ethylene methyl acrylate maleic anhydride, ethylene butyl acrylate glycidyl methacrylate (EBAGMA) and ethylene butyl acrylate carbon monoxide (EBACO) and butylacrylate (BA).

Examples of commercially available ethylene copolymers include those available from E. I. du Pont de Nemours and Company (DuPont), Wilmington, Del., carrying the trademarks of Surlyn®, Nucrel®, Appeel®, Bynel®, Elvaloy® and Elvax®.

Such ethylene copolymers can be produced by any means known to one skilled in the art using either autoclave or tubular reactors (e.g., U.S. Pat. No. 3,404,134, U.S. Pat. No. 5,028,674, U.S. Pat. No. 6,500,888 and U.S. Pat. No. 6,518,365).

For example, an ethylene copolymer can be produced at high pressure and elevated temperature in a tubular reactor. The inherent consequences of dissimilar reaction kinetics for the respective ethylene and alkyl(meth)acrylate (e.g. methyl acrylate) comonomers is alleviated or partially compensated by the intentional introduction of the monomers along the reaction flow path within the tubular reactor. Such tubular reactor-produced ethylene copolymer has a greater relative degree of heterogeneity along the polymer backbone (a more blocky distribution of comonomers), reduced long chain branching, and a higher melting point than one produced at the same comonomer ratio in a high pressure stirred autoclave reactor. For additional information for tubular reactor-produced and autoclave produced ethylene copolymers, see Richard T. Chou, Mimi Y. Keating and Lester J. Hughes, “High Flexibility EMA made from High Pressure Tubular Process”, Annual Technical Conference—Society of Plastics Engineers (2002), 60th(Vol. 2), 1832-1836. Tubular reactor produced ethylene copolymers are commercially available from DuPont. Certain such ethylene copolymers available from DuPont have a melt flow index (g/10 minutes) from about 0.1 to about 10, measured according to ASTM D1238 and comprise repeat units derived from an alkyl acrylate from about 5 to about 30 wt %, the weight percentages being based on the total weight of the ethylene copolymer.

An ethylene copolymer can also include fillers or additives such as slip additive (e.g. n-oleyl palmitamide, stearamide, and benhenamide), anti block agent such as silica (diatomaceous earth or silica dioxide particles), CaCO₃, UV stabilizer, pigment, or combinations of two or more thereof.

An ethylene copolymer can comprise, or be modified by including, from about 0.001 to about 35, or about 0.1 to about 30 wt % of at least one tackifier, the weight percentages being based on the total amount of the modified ethylene copolymer. The tackifier can enhance adhesion to differentiated substrates.

Any tackifier, also referred to as adhesive, known to one skilled in the art such as those disclosed in U.S. Pat. No. 3,484,405 can be used. Such tackifiers include a variety of natural and synthetic resins and rosin materials. The resins can be liquid, semi-solid to solid, or solid, including complex amorphous materials generally in the form of mixtures of organic compounds having no definite melting point and no tendency to crystallize. Such resins may be insoluble in water and can be of vegetable or animal origin, or can be synthetic resins. The resins can provide substantial and improved tackiness to the composition. Suitable tackifiers include, but are not limited to, para-coumarone-indene resins, terpene resins, butadiene-styrene resins, polybutadiene resins, hydrocarbon resins, rosins, and combinations of two or more thereof.

Generally the coumarone-indene resins have a molecular weight ranging from about 500 to about 5,000. Examples of resins of this type that are available commercially include those materials marketed as “Picco”-25 and “Picco”-100.

The terpene resins include styrenated terpenes and can have a molecular weight ranging from about 600 to 6,000. Examples of commercially available resins are marketed as “Piccolyte” S-100, as “Staybelite Ester” #10 (Eastman Chemical, Kingsport, Tenn.), which is a glycerol ester of hydrogenated rosin, and as “Wingtack” 95, which is a polyterpene resin. A terpene resin-based tackifier of note is derived from poly-limonene, a monomer recovered from the citrus industry, available as Piccolyte® C115 from Pinova.

The butadiene-styrene resins can have a molecular weight ranging from about 500 to about 5,000. Example of commercial product is marketed as “Buton” 100, a liquid butadiene-styrene copolymer resin having a molecular weight of about 2,500.

The polybutadiene resins can have a molecular weight ranging from about 500 to about 5,000. A commercially available example is that marketed as “Buton” 150, a liquid polybutadiene resin having a molecular weight of about 2,000 to about 2,500.

A hydrocarbon resin can be produced by catalytic polymerization of selected fractions obtained in the refining of petroleum, and can have a molecular weight ranging from about 500 to about 5,000. Examples of such resin are those marketed as “Piccopale”-100, and as “Amoco” and “Velsicol” resins. Similarly, polybutenes obtained from the polymerization of isobutylene may be included as a tackifier.

The tackifier may also include rosin materials, low molecular weight (such as, for example, 1300) styrene hard resins such as the material marketed as “Piccolastic” A-75, disproportionated pentaerythritol esters, and copolymers of aromatic and aliphatic monomer systems of the type marketed as “Velsicol” WX-1232. The rosin that may be employed in the present invention may be gum, wood or tall oil rosin but preferably is tall oil rosin. Also the rosin material may be modified rosin such as dimerized rosin, hydrogenated rosin, disproportionated rosin, or esters of rosin. Esters can be prepared by esterifying the rosin with polyhydric alcohols containing from 2 to 6 alcohol groups.

Another tackifier resin of note is Regalite R1125 (a hydro carbon) available from Eastman Chemical.

A more comprehensive listing of tackifiers, can be found in the TAPPI CA Report #55, February 1975, pages 13-20, a publication of the Technical Association of the Pulp and Paper Industry, Atlanta, Ga., which lists well over 200 tackifier resins that are commercially available.

The tackifier may be either combined directly with the ethylene copolymer or other components disclosed; or pre-melt compounded into a masterbatch formulation. Such technology is described in U.S. Pat. No. 6,255,395 and JP 2002 173,653, entire disclosures of both are incorporated herein. For example, poly-limonene may be blended with an ethylene/octane copolymer to prepare a tackifier masterbatch that can be added to the remaining components of the composition in a subsequent blending operation.

Some of the ethylene copolymers, which form the external heat sealing layer, can be further modified by mixing or blending them with polyethylene and/or polypropylene. Typical blends include from 5 to 50 wt % of polyethylene and/or polypropylene, the weight percentages being based on the total amount of ethylene copolymer blend.

Some of the ethylene copolymers which form the external heat sealing layer can be further modified by mixing or blending for example, about 50 to about 90 wt % of one or more of EVA and EMA and about 5 to about 50 wt %, preferably about 5 to about 40 wt % of an ionomer, the weight percentages being based on the total weight of the ethylene copolymers. Such blends may further comprise about 5 to about 10 wt % of an EVA masterbatch containing an additive such as slip and anti block concentrate. Specific examples of modified ethylene copolymers can include blend of (1) EVA (75 wt %), ionomer (18 wt %), and EVA masterbatch (slip additive and anti block agent; 7 wt %) and (2) EVA (87 wt %), acid copolymer (9 wt %), and EVA masterbatch (slip additive and anti block agent; 4 wt %), the weight percentages being based on the total amount of the modified ethylene copolymers. EVA can contain about 4 to about 35 wt % repeat units derived from vinyl acetate, the weight percentages being based on the total amount of the EVA. The copolymers containing slip and anti block, wishing not to be bound by theory, can improve extrusion processing and ease of handling the finished film product, but these additives can contribute to the difficulty for having a functional antifog as they affect surface area making wetting out of the coating more difficult.

The external heat sealing and/or any additional layer of the film structure according to the present invention may be produced from molten compositions disclosed herein by a number of methods known in the art (for example, cast film extrusion or blown film extrusion). The external heat sealing and/or any additional layer of the film structure according to the present invention can be oriented in one direction by hot-drawing in the machine direction with a tensioning device, and annealing. Such layers can also be oriented in two directions (machine direction and transverse direction) by suitable tensioning devices. Because processes for producing films are well known to one skilled in the art, the description of which is omitted herein for the interest of brevity.

The term “antifog agent” or “antifogging agent” refers to a chemical or substance effectively keeping water from condensing on the surface of a plastic film producing undesirable water droplets or fogging or retarding the formation of fog. The term “antifogging amount” is the amount that, when coated onto a film, can substantially reduce or remove fogging from the film that is exposed to water or vapor. Wishing not to be bound by theory, it is believed that the agent can reduce the surface tension of water thereby reducing the removing fog produced from water.

According to an embodiment of the present invention, the amount of the antifog agent is present in the external heat sealing layer from about 0.03 g to about 1.0 g, preferably from about 0.1 g to about 0.7 g, per square meter of the external heat sealing layer. Wishing not to be bound by theory, the more polar is the external heat sealing layer, the more antifog agent will be needed per square meter of the external heat sealing layer.

Antifog agent can be a surfactant or a residue of the surfactant that is approved for food use such as alkanoic acids or their ammonium or metal salts, alkanols, alkoxylated compounds, quaternary ammonium salts, alkali metal alkyl sulfates, alkali metal salts of alkaryl sulfonic acids, 1-alkyl pyridinium salts, or combinations of two or more thereof.

Of note is an alkanol or alkanoic acid (or its metal salts or its esters) such as, for example, sorbitan fatty esters, glycerol mono stearate, glycerol mono oleate, fatty alcohols, and combinations of two or more thereof. Of note is a glycerol mono oleate.

Multilayer film structures according to the present invention can be produced by any methods known to one skilled in the art. For example, a multilayer film structure can be produced by charging each of the polymers for the different layers of the structure into separate extruders and melting the component and pumping the melted component through a pipe into a feed block that layers the different flows together just prior to entering an extrusion die manifold as a single flow stream. A molten curtain of multiple layers exits the extrusion die and is deposited onto a moving roll which transfers the cooling multi-layer sheet material into a counter rotating moving roll through a gap or nip and then typically to a third cooling roller and subsequently through a take-off system to another nip between two rollers which pulls the sheet to a take-off system.

Examples of polymer materials which can be used for producing additional layers (in addition to the external heat sealing layer) for the multilayer film structures of the present invention include nylon, polypropylene, polyethylene, ionomers, acid copolymers, polyethylene vinyl acetate, polyethylene terephthalate, polystyrene, polyethylene vinyl alcohol (EVOH), polyvinylidene chloride, and combinations of two or more thereof.

For example, one or more layers of a multilayer film structure of the present invention can have heat shrinkages of 5% to 10% more than the heat shrinkage of the external heat sealing layer disclosed above.

Such heat shrinkable layers can comprise about 80 wt % or more of a polyester like polyethylene terephthalate and can be biaxially oriented in the range of about 5% to about 55%, or about 5 to 30%, or about 5 to 10% shrink factor.

An adhesive can be used between two or more layers of a multilayer film structure according to the present invention. Any adhesive can be employed such as solvent-less laminating adhesives such as waterborne acrylic emulsions, polyurethane dispersions, elastomer (e.g., polyurethanes), and one and two part 100% solids polyurethane systems are well known to one skilled in the art.

Solvent type adhesives can also be used such as polyether urethane (e.g., Lamal HSA/Catalyst CR-1-80 available from Rohm & Haas, Philadelphia, Pa.). A Lamal HSA adhesive with coreactant laminating adhesive can be applied by any of the well known coating techniques, preferably a gravure station coating typically used in solution coating processes.

Film structures according to the present invention can include a layer that is not permeable to oxygen, moisture, or both. Such barrier layer may be useful in many food packaging applications. The barrier layer can be made from, for example, EVOH or a vinylidene polymer such as polyvinylidine chloride copolymer (PVDC).

The present invention refers also to a process for producing a film structure as described above. The antifog agent, which is preferably a glycerol mono oleate, is dissolved in any solvent, preferably one that has a high evaporation rate or volatility under the temperature and pressure of application. For example, it can have an evaporation rate of >0.01 relative to n-butyl acetate which has an assigned value of 1 according to ASTM D3539-87. A solvent preferably can be dried at less than 80° C.

Solvents can include alcohols, ketones, esters, ethers, acids, hydrocarbons or derivatives thereof, and combinations of two or more thereof.

Examples of solvents include methanol, ethanol, propanol, isopropanol, acetone, ethyl acetate, butyl acetate, methyl ethyl ketone, tetrahydrofuran, dioxane, octane, decane, cyclohexane, toluene, xylene, methylene chloride, methylene dichloride, ethylene dichloride, carbon tetrachloride, chloroform, perchloroethylene, white spirit, mineral spirits, naphtha, and combinations of two or more thereof.

Preferably the solvent is an alcohol and, still more preferably, it is isopropanol.

Dilution with a solvent can range from 0.2 to 10 wt % of antifog agent, the weight percentage being based on the total weight of the resulting solution of antifog agent. Wishing not to be bound by theory, it is believed that the more polar is the polar monomer of the ethylene copolymer on which the external heat sealing layer of the film structure is based, the more concentrated the antifog agent solution should be.

The antifog agent solution can be coated or applied onto an ethylene copolymer external heat sealing layer as disclosed above by any means known to one skilled in the art such as, for example, spraying, dipping, brushing, vapor depositing, printing, spin coating, transferring, flow coating, and combinations of two or more thereof.

The antifog agent solution can be applied onto such external heat sealing layer, for example, by means of a gravure or anilox cylinder. For example, a quadrangular cell can be used. Other types of engraved cylinders available are pyramid and trihelicals. Gravure cylinder cell size and dilution ratios can be adjusted to apply a desired amount of antifog coating depending on the type of cylinder and of ethylene copolymer used. The antifog agent can be applied as a pattern or registered on the external heat sealing similar to printing methods. It may be desirable that the antifog agent is in areas on the external heat sealing where it is useful and out of the area where the external heat sealing is actually sealed. Preferred conditions include direct gravure with application cell size (110-200 lines).

The invention also relates to packaging for food comprising the film structure described above. For example, a container can have an open end which is covered with a film structure as disclosed above, such as for example a peelable lid, and can have any shape such as boxes, blister packs, bottles, trays, cups, and other like-bottomed containers, or forms such as square, rectangular, triangular, round, trapezoid, and other shapes or forms known to one skilled in the art. The lid can have a thickness in the range of 12-75, preferably 12-20 micrometers. The container can include a product such as produce or fresh produce, meats, readily to eat meals, prepared foods, sea foods, or combinations of two or more thereof. The container can be made from any materials known to one skilled in the art such as foam fiber, metal, plastics, papers, or combinations of two or more thereof.

### EXAMPLES

The following examples are provided to illustrate, not to unduly limit the scope of, the invention. In the examples the antifog concentration percentages are by weight and are based on the total weight of the antifog solution.

An antifog agent was added to the surface of the external heat sealing of a film structure according to the invention by topical coating using the gravure cylinder metering method. Differential film structures can be fabricated using either solvent or solvent-less type adhesive systems. Antifog agents tested were supplied by Ciba Specialty Chemical under the trade name Atmer™, in liquid form and could be diluted in ethanol, methanol or isopropanol to the desired concentration level. The antifog agents tested were Atmer™ 1440 and Atmer™ 100. Atmer™ 1440 is preferred due to overall antifog performance and being most environmentally friendly.

Effective antifog concentrations ranged from 0.2 to 10 wt % based on the type of ethylene copolymer of which the heat sealing layer is based and on the gravure cylinder selected in the examples below. Antifog agent concentrations varied with different gravure cylinders or with different engraved cell sizes. Gravure cylinder cell size and dilution ratios could affect the amount of antifog coating applied to the heat sealing layer of the film structure. Typical preparations of multilayer structures having a heat sealing layer coated with an antifog agent included applying adhesive by gravure to 1^{st} base film (e.g. polyester, nylon or polypropylene) at a coating station as a carrier for the adhesive; continuing through a hot air dryer (1^{st} dryer system); combining with a 2^{nd} sealant film applying pressure via hot nip roll; fully laminating roll passes through 2^{nd} gravure station that applies diluted antifog agent directly onto sealant side of 2nd film; rolling passes through 2^{nd} dryer system; and onto winding station for finishing rolling.

If a second gravure and drying station were not available on existing equipment, the roll was wound up first after laminating; the adhesive was replaced at the coating station with diluted antifog agent; and the roll then unwound as it passed through the gravure station and coating said film with antifog agent and passed through the dryer station a second time winding up into the finished roll.

### Example 1

Antifog Coating

In this example a single gravure and drying station process was used. A first substrate of 48 gauge (12μ) polyester (PET) film known under the trade name Mylar® supplied by DuPont Teijin Films was adhesive-laminated to a second substrate of 2.5 mil (63.5μ) blown film coextruded structure. Two blown film structures for lamination were produced as follows: (1) 1.0 mil (25.4μ) HDPE/0.5 mil (12.7μ) HDPE+LDPE blend/0.5 mil (12.7μ) Modified EVA and (2) 1.0 mil (25.4μ) HDPE/0.5 mil (12.7μ) HDPE+LDPE blend/0.5 mil (12.7μ) Modified EMA.

Two types of modified EVA were used: Appeel® 2044 (EVA A) and Appeel® 11D704 (EVA B).

Three types of modified EMA were used: Appeel® 20D745 (EMA A) and Appeel® 20D808 (EMA B) and Appeel® 20D751 (EMA C) supplied by DuPont.

The lamination was made by (1) applying a solvent type adhesive (Adcote 503A/Catalyst F available from Rohm & Haas, Philadelphia, Pa.) to the corona-treated and coated side of Mylar® by an engraved 110 quadrangular gravure cylinder at a coating station and (2) running and drying the adhesive coated web through a hot air oven at 160° F. (71.1° C.) and (3) under pressure hot nipping the Mylar® to the secondary coextruded films on the corona treated HDPE side at 160° F. (71.1° C.) and winding up the roll thus completing the lamination. The adhesive and solvent for dilution were selected for good adhesion between the Mylar® and blown film HDPE side of the coextruded films. Adcote 503A adhesive was a polyether urethane component of a two-component laminating adhesive, which required the use of a coreactant. This polyether urethane, in conjunction with coreactant F, functioned as an adhesive for bonding differentiated film materials.

The adhesive in the coating station was replaced with a diluted solution of Atmer 1440. Diluting of 3, 5 and 7% of the Atmer 1440 antifogging agent in isopropanol to make the solution. The laminate was unwound and taken through the coating station using selected 110 and 200 quad engraved gravure cylinder to apply the antifog solution to the modified EVA and EMA heat sealable sides of the film.

After the antifog solution was applied, the web was passed though a hot air dryer at 160° F. (71.1° C.) in order to remove the solvent and dry the surface. The roll was then wound up into the finished product. The same process was used applying 2 wt %, 3 wt % and 5 wt % antifog solutions to the same laminated film structure. In all cases the film remained clear and had excellent sealability.

### Example 2

The example was carried with Intra Roto Laminator/Coater, 200 Quadrangular coating cylinder by coating antifog solution onto the sealant surface of each modified EVA and EMA film at a speed of 50 ft/min (15,24 m/min) to make an antifog-coated film. The antifog-coated film was dried at 160° F. (71° C.) by removing any residual solvent and curing the coating on the surface of the film. Antifog agent was Atmer 1440 topical solution (3 or 5 wt %) in isopropanol. Wet paper towel was placed in the bottom of a polypropylene tray, which was sealed hermetically with the antifog film leaving headspace between the wet towel and plastic lidding film. The lidded tray was exposed at 35° F. (1.67° C.). At time intervals (2, 4, 6, 24, 48 hours and 15 days), the appearance of the film was observed and recorded (Table 1). Appearance was rated as 1 (fogging/condensate), 2 (clear condensate-many droplets), 3 (clear/condensate-few droplets), 4 (clear/condensate-minimal droplets), 5 (clear condensate-total wetout 1 drop), and 6 (no visible change/no condensate).

TABLE 1

| | AF Sol. Coat | AF Coat | | | | | | |
|---|---|---|---|---|---|---|---|---|
| Polymer | (wt %)¹⁾ | (g/m²)²⁾ | 2 Hours | 4 Hours | 6 Hours | 24 Hours | 48 Hours | 15 Days |
| EVA B | 3 | 0.13 | 5 | 6 | 6 | 6 | 6 | 3 |
| EVA B | 5 | 0.28 | 5 | 6 | 6 | 6 | 6 | 3 |
| EVA A | 3 | 0.13 | 5 | 6 | 6 | 6 | 6 | 3 |
| EVA A | 5 | 0.28 | 5 | 6 | 6 | 6 | 6 | 3 |
| EMA A | 3 | 0.13 | 4 | 4 | 4 | 4 | 4 | 3 |
| EMA A | 5 | 0.28 | 4 | 4 | 4 | 4 | 3 | 3 |
| EMA B | 5 | 0.28 | 4 | 4 | 4 | 4 | 4 | 4 |

¹⁾Antifog agent concentration of the solution applied onto the film.
²⁾Antifog agent weight per square meter of the heat sealing layer

### Example 3

The runs shown in Example 2 were repeated with either Modified EVA or Modified EMA as base polymer film coated with antifog. The runs were carried out as disclosed above and the results are shown in Table 2 where “cell” denotes lines of quadranger gravure cylinder cells.

TABLE 2

| | Sample | AF Sol. | AF Coat | | | | | | | |
|---|---|---|---|---|---|---|---|---|---|---|
| Polymer | No. | Coat¹⁾ | (g/m²)²⁾ | Cell | 2 Hours | 4 Hours | 6 Hours | 24 Hours | 48 Hours | 15 Days |
| EVA A | 1 | 5 | 0.28 | 110 | 6 | 5 | 5 | 5 | 5 | 5 |
| EVA A | 2 | 7 | 0.43 | 200 | 6 | 6 | 6 | 6 | 5 | 5 |
| EVA B | 3 | 5 | 0.28 | 110 | 5 | 4 | 4 | 3 | 3 | 3 |
| EVA B | 4 | 7 | 0.43 | 200 | 5 | 4 | 4 | 3 | 3 | 3 |
| EMA A | 5 | 5 | 0.28 | 110 | 5 | 5 | 5 | 4 | 4 | 4 |
| EMA A | 6 | 7 | 0.43 | 200 | 5 | 5 | 5 | 5 | 5 | 5 |
| EMA B | 7 | 5 | 0.28 | 110 | 1 | 1 | 1 | 1 | 3 | 3 |
| EMA B | 8 | 7 | 0.43 | 200 | 1 | 1 | 1 | 1 | 3 | 3 |
| EMA C | 9 | 5 | 0.28 | 110 | 6 | 5 | 5 | 5 | 5 | 5 |
| EMA C | 10 | 7 | 0.43 | 200 | 6 | 5 | 5 | 5 | 5 | 5 |

¹⁾Antifog agent concentration of the solution applied onto the sealing layer, wt %.
²⁾Antifog agent weight per square meter of the heat sealing layer

### Example 4

Film structures of Example 3 were bonded to various rigid substrates by heat sealing. The sealability of these structures were measured and compared to the sealability of the same structures bonded to the same substrates but including no antifog agent (control samples, characterized by a “C” before the sample number in Table 3 below). The sealability was measured according to DuPont Test Method CR-188, which corresponds to ASTM Test Method F88. The two methods differed only in the Instron Crosshead speed which is 12 inches/min (30.48 cm/min) according to the DuPont test and in the range between 8 and 12 inches/min (between 20.32 and 30.48 cm/min) according to the ASTM test.

The test conditions were:

Seal Time: 1 second dwell

Seal Pressure: 40 psi

Seal Temperatures: 107° C., 121° C., 135° C., 149° C., 163° C.

Sample Width: 1 inch (25 mm) test strips

Replicates: 5

Instron Crosshead Speed: 12 inches (30.48 cm) per minute

Peel angle: 90° T peel

Peel Conditions: after 3 days, at 23° C. and 0° C.

Peel Measurement: Grams per inch (25 mm) of width

The test results are given in Table 3 wherein the sample numbers are the same as those given in Table 2.

TABLE 3
Peelability at 23° C./0° C. (grams/inch(25 mm))

| Sample No.¹⁾ | Substrate²⁾ | 107° C.³⁾ | 121° C.³⁾ | 135° C.³⁾ | 140° C.³⁾ | 163° C.³⁾ |
|---|---|---|---|---|---|---|
| 2 | APET | 797/1845 | 897/1482 | 1646/2757 | 1774/2363 | 1683/2883 |
| C2 | APET | 1268/2222 | 1220/2649 | 1645/2569 | 1828/1379 | 2633/2287 |
| 4 | PP | 294/38 | 591/247 | 540/427 | 1092/1032 | 2285/897 |
| C4 | PP | 364/125 | 650/152 | 636/349 | 481/454 | 1671/1350 |
| 6 | PVC | 973/1442 | 1432/2994 | 1687/2307 | 902/3079 | 1321/4545 |
| C6 | PVC | 945/804 | 1204/2544 | 1919/3116 | 1733/2918 | 1187/3101 |
| 10 | PVC | 638/499 | 676/1575 | 1073/2743 | 752/2597 | 870/2744 |
| C10 | PVC | 745/859 | 878/1851 | 1489/2352 | 774/2274 | 827/3410 |

¹⁾The sample numbers are the same as in Table 2 of Example 3. The letter “C” characterizes the control sample.
²⁾APET Amorphous polyester terephtalate PP Polypropylene PVC Polyvinylchloride
³⁾Sealing temperature of the sample to the rigid substrate

Data in Table 3 show that film structures according to the present invention, when exposed and pulled at 0° C., maintain the same trend, in terms of heat seal strength, if compared to the same film structures containing no antifog agent. In some cases the heat seal strength even increases if compared to that of the same film structures containing no antifog agent. This is unexpected since it is known that the presence of anti fog agents normally affects, in a negative way, the heat seal strength at temperatures around 0° C.

The use of antifog film structures according to the present invention may therefore facilitate transporting and moving products through the conventional chilled food distribution chains.

1. An antifog mono or multilayer film structure comprising at least an external heat sealing layer coated with an antifog agent wherein the external heat sealing layer comprises, or is produced from, an ethylene copolymer, modified ethylene copolymer, or both; the ethylene copolymer is a copolymer or terpolymer or tetrapolymer comprising repeat units derived from ethylene and about 5 to about 50 wt % of one or more polar monomers chosen from the group consisting of vinyl alkanoic acid, acrylic acid, alkyl acrylic acid and alkyl acrylate, the weight percentages being based on the total weight of the ethylene copolymer or modified ethylene copolymer.

2. The film structure of claim 1, wherein the polar monomer is vinyl acetic acid, vinyl acetate, vinyl propionate, acrylic acid, methacrylic acid, ethacrylic acid, vinyl acetate, methyl acrylate, ethyl acrylate, methyl methacrylate, ethyl methacrylate, propyl acrylate, propyl methacrylate, isopropyl acrylate, isopropyl methacrylate, butyl acrylate, butyl methacrylate, isobutyl acrylate, isobutyl methacrylate, tert-butyl acrylate, tert-butyl methacrylate, octyl acrylate, octyl methacrylate, undecyl acrylate, undecyl methacrylate, octadecyl acrylate, octadecyl methacrylate, dodecyl acrylate, dodecyl methacrylate, 2-ethylhexyl acrylate, 2-ethylhexyl methacrylate, isobornyl acrylate, isobornyl methacrylate, lauryl acrylate, lauryl methacrylate, 2-hydroxyethyl acrylate, 2-hydroxyethyl methacrylate, glycidyl acrylate, glycidyl methacrylate, poly(ethylene glycol)acrylate, poly(ethylene glycol)methacrylate, poly(ethylene glycol)methyl ether acrylate, poly(ethylene glycol)methyl ether methacrylate, poly(ethylene glycol)behenyl ether acrylate, poly(ethylene glycol)behenyl ether methacrylate, poly(ethylene glycol)4-nonylphenyl ether acrylate, poly(ethylene glycol)4-nonylphenyl ether methacrylate, poly(ethylene glycol)phenyl ether acrylate, poly(ethylene glycol)phenyl ether methacrylate, dimethyl maleate, diethyl maleate, dibutyl maleate, dimethyl fumarate, diethyl fumarate, dibutyl fumarate, dimethyl fumarate, or combinations of two or more thereof and is preferably vinyl acetate, acrylic acid, methacrylic acid, or alkyl(meth)acrylate.

3. The film structure of claim 2 wherein the ethylene copolymer of the external heat sealing layer is a blend comprising (1) about 50 to about 90 wt % of one or more of ethylene vinyl acetate and ethylene methyl acrylate and (2) about 5 to about 40 wt % of an ionomer, the weight percentages being based on the total weight of the external heat sealing layer.

4. The film structure of claim 3 wherein the blend further comprises about 5 to about 10 wt % of an ethylene vinyl acetate copolymer masterbatch containing one or more slip additives and one or more anti block agents, the weight percentages being based on the total weight of the external heat sealing layer.

5. The film structure of claim 1 wherein the antifog agent is present from about 0.03 g/m² to about 1 g/m² of the external heat sealing layer.

6. The film structure of claim 4 wherein the antifog agent is present from about 0.03 g/m² to about 1 g/m² of the external heat sealing layer.

7. The film structure of claim 3 wherein the antifog agent is an alkanol or an alkanoic acid, including its metal salts and its esters.

8. The film structure of claim 6 wherein the antifog agent is an alkanol or an alkanoic acid, including its metal salts and its esters.

9. The film structure of claim 7 wherein the antifog agent is sorbitan fatty esters, glycerol mono stearate, glycerol mono oleate, fatty alcohol, or combinations of two or more thereof.

10. The film structure of claim 8 wherein the antifog agent is sorbitan fatty esters, glycerol mono stearate, glycerol mono oleate, fatty alcohol, or combinations of two or more thereof.

11. The film structure of claim 10 wherein the antifog agent is a glycerol mono oleate.

12. The film structure of claim 11 wherein the external heat sealing layer comprises an ethylene copolymer modified with from about 0.001 to about 35 wt % of at least one tackifier, the weight percentages being based on the total amount of the modified ethylene copolymer.

13. The film structure of claim 12 wherein the tackifier includes para-coumarone-indene resins, terpene resins, butadiene-styrene resins, polybutadiene resins, hydrocarbon resins, rosins, or combinations of two or more thereof.

14. The film structure of claim 13 comprising one or more additional layers, in addition to the external heat sealing layer, wherein the additional layer comprises or is produced from nylon, polypropylene, polyethylene, ionomers, acid copolymers, polyethylene vinyl acetate, polyethylene terephthalate, polystyrene, polyethylene vinyl alcohol, polyvinylidene chloride, or combinations of two or more thereof.

15. A process comprising dissolving an antifog agent in a solvent to produce an antifog agent solution; applying the antifog agent solution onto an external heat sealing layer to produce a coating thereon; and optionally curing the coating wherein the external heat sealing layer is one of the layers of a film structure as recited in claim.

16. The process of claim 15 wherein the solvent is an alcohol, isopropanol, or combinations thereof and the film structure is as recited in claim 6.

17. The process of claim 16, wherein the film structure is as recited in claim 14.

18. The process of any claim 17, wherein the antifog agent solution contains from about 0.2 to about 10 wt % of the antifog agent.

19. The process of any claim 18, wherein the antifog agent is a glycerol mono oleate.

20. A packaging comprising the film structure as recited in claim 1.

21. The packaging of claim 20 wherein the film structure is as recited in claim 14.

22. The packaging of claim 21 being a container comprising an open end which is covered with the film structure wherein the container optionally comprises produce, meats, ready to eat meals, prepared foods, sea foods, or combinations of two or more thereof.
